(19) United States
(12) Patent Application Publication
(10) Pub. No.: US 2018/0138999 A1
(43) Pub. Date: May 17, 2018

(54) INFORMATION PROCESSING METHOD, INFORMATION PROCESSING DEVICE, AND STORAGE MEDIUM

(71) Applicant: FUJITSU LIMITED, Kawasaki-shi (JP)

(72) Inventors: Kazuo Hida, Sagamihara (JP); Takashi Ohno, Kobe (JP); Tatsuro Matsumoto, Yokohama (JP)

(73) Assignee: FUJITSU LIMITED, Kawasaki-shi (JP)

(21) Appl. No.: 15/791,474

(22) Filed: Oct. 24, 2017

(30) Foreign Application Priority Data
Nov. 14, 2016 (JP) 2016-221967

(51) Int. Cl. H04H 20/62; G08G 1/0967; G06F 1/32; G06F 3/048

(52) U.S. Cl. CPC H04H 20/62; G08G 1/096716; G06F 3/048; G08G 1/096775; G06F 1/3203; G08G 1/09675

(57) ABSTRACT

An information processing method executed by an information processing device including a sensor and a processor, the information processing method includes acquiring, by the sensor, observation information indicating a situation; extracting, by the processor, one or more contents corresponding to the observation information from among a plurality of contents by referring to information in which an identifier identifying a situation and a content are associated with each other for each of the plurality of contents; determining one or more target contents from among the one or more contents based on priorities associated with the one or more contents; and executing a program of one of the determined one or more target contents.

### CROSS-REFERENCE TO RELATED APPLICATION

This application is based upon and claims the benefit of priority of the prior Japanese Patent Application No. 2016-221967, filed on Nov. 14, 2016, the entire contents of which are incorporated herein by reference.

### FIELD

The embodiment discussed herein is related to an information processing method, an information processing device, and a storage medium.

### BACKGROUND

In a conventional system, contents in accordance with conditions on a place and time are distributed to a terminal satisfying the conditions. In such a system, for example, the terminal accesses to a server when a result of detection by a sensor satisfies a predetermined condition. Upon the access from the terminal, the server distributes contents in accordance with the predetermined condition.

In a related technology (Japanese Laid-open Patent Publication No. 2013-141050), for example, when the degree of interest match of a content being viewed on a display terminal has become lower than that of another content, recommended content information that specifies the other content as a recommended content is transmitted to the display terminal. The degree of interest match is obtained by evaluating a correlation of user interest information indicating interest of a user of the display terminal with each of a content being viewed on the display terminal and another content. In another disclosed technology (Japanese Laid-open Patent Publication No. 2001-067594), among information transmitted through broadcast communication, information corresponding to the move path of a moving object is displayed on an information terminal such as a car navigation system. In a disclosed portable terminal device (Japanese Laid-open Patent Publication No. 2011-159077), display array of icons is changed in accordance with a use frequency of a user.

However, in these related technologies, a large number of contents are distributed to a terminal satisfying various conditions related to a place and a time, which complicates content display at the terminal in some cases. For example, when the terminal simultaneously satisfies a plurality of conditions, a content corresponding to each of the plurality of conditions is distributed to the terminal. In addition, a large amount of time for accumulating a sufficient amount of a use history is requested to reduce content display complication at the terminal based on the accumulated use history. For these reasons, it is desirable to reduce display complication in a short time.

### SUMMARY

According to an aspect of the invention, an information processing method executed by an information processing device including a sensor and a processor, the information processing method includes acquiring, by the sensor, observation information indicating a situation; extracting, by the processor, one or more contents corresponding to the observation information from among a plurality of contents by referring to information in which an identifier identifying a situation and a content are associated with each other for each of the plurality of contents; determining one or more target contents from among the one or more contents based on priorities associated with the one or more contents; and executing a program of one of the determined one or more target contents.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary information processing method according to an embodiment;

FIG. 2 is a diagram illustrating an exemplary system configuration of an information processing system;

FIG. 3 is a block diagram illustrating an exemplary hardware configuration of an information processing device;

FIG. 4 is a block diagram illustrating an exemplary hardware configuration of a server;

FIG. 5 is a diagram (1) illustrating an exemplary stored content of a situation definition information DB;

FIG. 6 is a diagram (1) illustrating an exemplary stored content of an application store;

FIG. 7 is a diagram (1) illustrating an exemplary stored content of a situation priority information DB;

FIG. 8 is a block diagram illustrating an exemplary functional configuration of the information processing device;

FIG. 9 is a diagram (1) illustrating an exemplary stored content of a display candidate application list;

FIG. 10 is a diagram illustrating exemplary application determination;

FIG. 11 is a diagram illustrating an exemplary application list screen;

FIG. 12 is a block diagram illustrating an exemplary functional configuration of the server;

FIG. 13 is a diagram (1) illustrating exemplary setting of a priority corresponding to a situation indicating a place;

FIG. 14 is a diagram (2) illustrating exemplary setting of a priority corresponding to a situation indicating a place;

FIG. 15 is a flowchart (1) of an exemplary procedure of display control processing at the information processing device;

FIG. 16 is a flowchart (2) of the exemplary procedure of display control processing at the information processing device;

FIG. 17 is a flowchart of an exemplary procedure of distribution processing at the server;

FIG. 18 is a flowchart of an exemplary procedure of priority setting processing at the server;

FIG. 19A is a diagram (2) illustrating an exemplary stored content of the situation definition information DB;

FIG. 19B is a diagram (3) illustrating an exemplary stored content of the situation definition information DB;

FIG. 20 is a diagram (2) illustrating an exemplary stored content of the application store; and

FIG. 21 is a diagram (2) illustrating an exemplary stored content of the situation priority information DB.

### DESCRIPTION OF EMBODIMENT

An embodiment of an information processing system, an information processing device, an information processing method, and an information processing program according to the present disclosure will be described in detail below with reference to the accompanying drawings.

### Embodiment

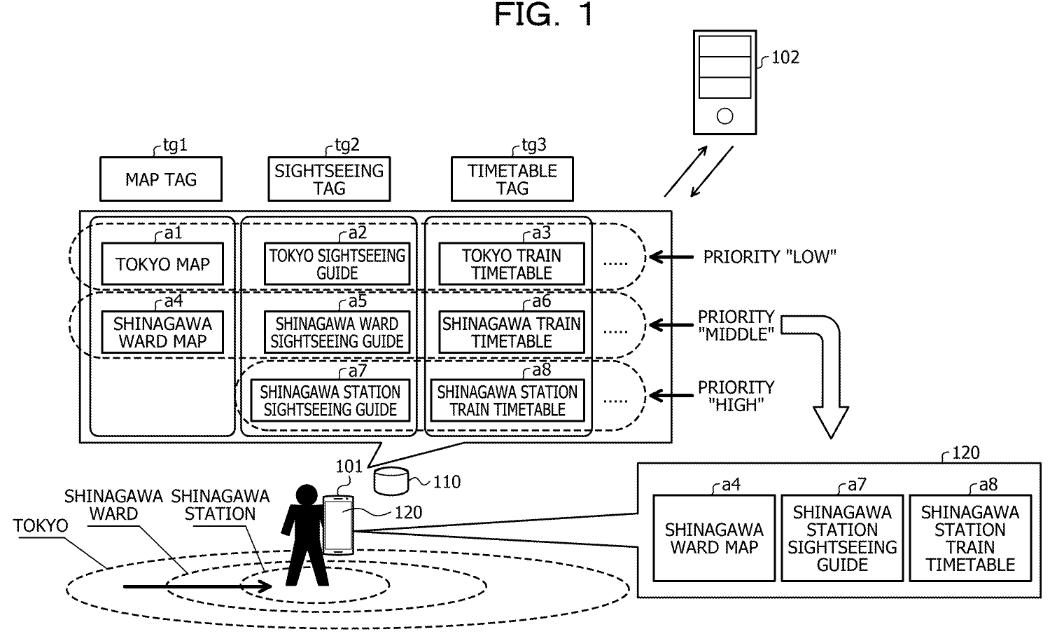

FIG. 1 is a diagram illustrating an exemplary information processing method according to an embodiment. In FIG. 1, an information processing device 101 includes a storage unit 110 and a display screen 120, and is a computer configured to determine a display manner when one or a plurality of contents stored in the storage unit 110 are displayed on the display screen 120. Examples of the contents include an application, moving image data, image data, and sound data.

In a system, contents in accordance with conditions on a place and time are distributed to a terminal satisfying the conditions. This system allows distribution of contents in accordance with a situation (place and time) that the terminal is in. When such a system is widely available, a large number of contents are distributed to a terminal satisfying a plurality of conditions.

For example, assume a case in a “place” is used as a condition and an application for sightseeing solution is provided at each place. In this case, when an application for similar usage is provided as an application for sightseeing solution at each place, a large number of unnecessary applications having similar functions are displayed on the terminal, potentially causing complication of display on the terminal.

To reduce the complication of display at a terminal, for example, interest of a user is estimated based on, for example, a content use history of the user, and a display priority is determined from the estimated interest. However, the determination of the priority based on the use history of the user requests accumulation of a sufficient amount of use history to determine an appropriate priority, and thus requests a large amount of time to reduce complication of content display at the terminal. Thus, it is difficult to sufficiently accumulate the use history of the user when, for example, a community lends the terminal to a sightseer and provides an application for sightseeing solution.

For this reason, the present embodiment describes below an information processing function to easily reduce display complication without a time for accumulating the use history of a user or the like. The following describes exemplary processing at a device (hereinafter, the information processing device 101) having the information processing function.

(1) The information processing device 101 acquires observation information indicating a situation. The observation information is, for example, information specifying the current position and the current date and time of the information processing device 101. The observation information is regularly or irregularly acquired.

(2) Upon the acquisition of the observation information, the information processing device 101 acquires, from a device (hereinafter, an information providing device 102) having an information providing function, a content that corresponds to a condition satisfied by the observation information and to which a priority is applied based on an inclusive relation with any other condition satisfied simultaneously with the above condition in some cases. Then, the information processing device 101 stores the acquired content in the storage unit 110. The information providing device 102 may be mounted on hardware separated from or same as that of the information processing device 101.

A condition is related to a situation. Thus, when the observation information satisfies a condition, it is indicated that the information processing device 101 is in a situation corresponding to the condition. Determination of which condition is satisfied by the observation information is performed at the information processing device 101. However, the information providing device 102 may receive the observation information from the information processing device 101 and determine which condition is satisfied based on the received observation information.

The information providing device 102 is a computer configured to store, in association with a condition related to a situation, a content to which a priority is applied based on an inclusive relation with any other condition satisfied simultaneously with the above condition in some cases. In an inclusive relation between conditions, one of the conditions is included in or includes the other condition physically or logically.

Specifically, when a particular condition is included in another condition, a priority applied to a content corresponding to the particular condition is higher than that of a content corresponding to the other condition. When a particular condition includes another condition, a priority applied to a content corresponding to the particular condition is lower than that of a content corresponding to the other condition. In other words, a priority is set based on an assumption that nearby information is more valuable to a user. For example, higher priorities are set for applications provided by Shinagawa Station, which is geographically included in Tokyo and Shinagawa Ward, than applications provided by local governments of Tokyo and Shinagawa Ward.

In the example illustrated in FIG. 1, when an user of the information processing device 101 has entered Tokyo, the information providing device 102 distributes, to the information processing device 101, applications a1, a2, and a3 corresponding to condition “Tokyo”, which is satisfied by the observation information indicating the position of the information processing device 101. Priority “Low” is applied to the applications a1, a2, and a3.

Condition “Tokyo” is satisfied when the position of the information processing device 101, which is indicated by the observation information, is included in the range of Tokyo.

When the user of the information processing device 101 has entered Shinagawa Ward, the information providing device 102 distributes, to the information processing device 101, applications a4, a5, and a6 corresponding to condition “Shinagawa Ward”, which is satisfied by the observation information indicating the position of the information processing device 101. Priority “Middle” is applied to the applications a4, a5, and a6.

When the user of the information processing device 101 has entered Shinagawa Station, the information providing device 102 distributes, to the information processing device 101, applications a7 and a8 corresponding to condition “Shinagawa Station”, which is satisfied by the observation information indicating the position of the information processing device 101. Priority “High” is applied to the applications a7 and a8. As a result, the applications a1, a2, a3, a4, a5, a6, a7, and a8 are stored in the storage unit 110 when the user of the information processing device 101 has entered Shinagawa Station.

(3) The information processing device 101 determines one or a plurality of contents stored in the storage unit 110 based on priorities thereof. Specifically, for example, the information processing device 101 may determine a display manner of displaying some contents having highest priorities among one or a plurality of contents stored in the storage unit 110.

For example, the information processing device 101 may compare the priorities of one or a plurality of contents stored in the storage unit 110 and having an identical usage based on tags thereof. Then, the information processing device 101 may determine contents for each usage based on a result of the comparison.

A tag is information indicating usage of a content. In the example illustrated in FIG. 1, a tag tg1 (map tag) is applied to the applications a1 and a4, a tag tg2 (sightseeing tag) is applied to the applications a2, a5, and a7, and a tag tg3 (timetable tag) is applied to the applications a3, a6, and a8.

In this case, for example, the information processing device 101 compares the priorities of the applications a1 and a4 to which the tag tg1 is applied, and determines the application a4 having the highest priority to be a display target application. For example, the information processing device 101 compares the priorities of the applications a2, a5, and a7 to which the tag tg2 is applied, and determines the application a7 having the highest priority to be a display target application. For example, the information processing device 101 compares the priorities of the applications a3, a6, and a8 to which the tag tg3 is applied, and determines the application a8 having the highest priority to be a display target application.

(4) The information processing device 101 displays one or a plurality of contents thus determined. Specifically, for example, the information processing device 101 displays contents determined for each usage. In the example illustrated in FIG. 1, the applications a4, a7, and a8 having the highest priorities are displayed on the display screen 120 for the respective tags tg1, tg2, and tg3 (usages).

In this manner, the information processing device 101 may acquire, from the information providing device 102, a content that corresponds to a condition satisfied by acquired observation information and to which a priority is applied based on an inclusive relation with any other condition satisfied simultaneously with the above condition in some cases, and may store the content in the storage unit 110. Then, the information processing device 101 may determine one or a plurality of contents stored in the storage unit 110 based on priorities thereof.

Accordingly, priorities set to contents based on an inclusive relation among a plurality of conditions that are simultaneously satisfied in some cases may be used to narrow down contents to be displayed on the display screen 120, and determine a display order of contents on the display screen 120. Thus, for example, display complication may be reduced in a short time without a time for accumulating the use history of the user or the like.

In the example illustrated in FIG. 1, the display screen 120 displays the applications a4, a7, and a8 having the highest priorities for the respective usages among the applications a1, a2, a3, a4, a5, a6, a7, and a8 stored in the storage unit 110. This allows the user to easily determine and use an application likely to be most useful in the current situation.

The following describes an exemplary system configuration of an information processing system 200 according to the embodiment. The following description will be made with an example in which the information processing system 200 is applied to a service that provides an application for sightseeing.

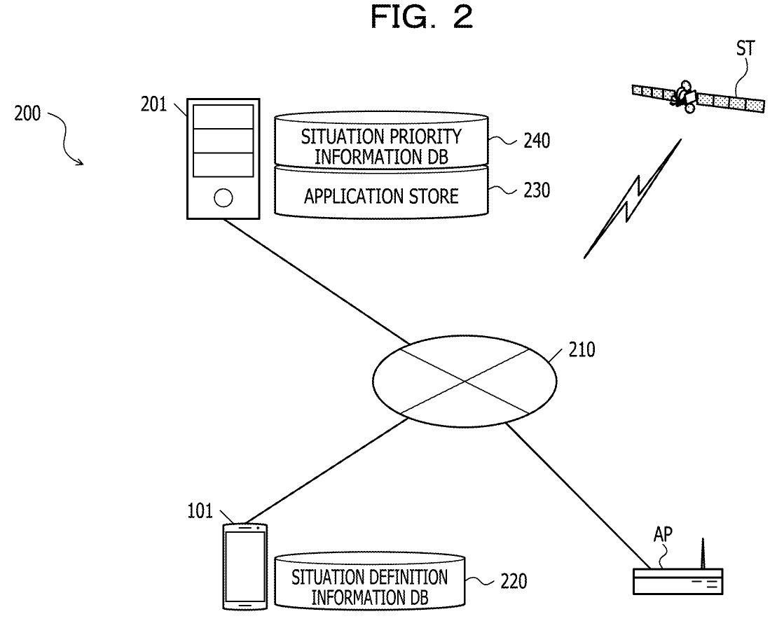

FIG. 2 is a diagram illustrating the exemplary system configuration of the information processing system 200. In FIG. 2, the information processing system 200 includes the information processing device 101 and a server 201. In the information processing system 200, the information processing device 101, the server 201, and an access point AP are connected with each other through a wired or wireless network 210. Examples of the network 210 include the Internet, a mobile communication network, a local area network (LAN), and a wide area network (WAN). In the example illustrated in FIG. 2, the information processing device 101 and the server 201 are each mounted on separate hardware, but the information processing device 101 and the server 201 may be mounted on identical hardware. In such a case, the network 210 and the access point AP between the information processing device 101 and the server 201 are not requested.

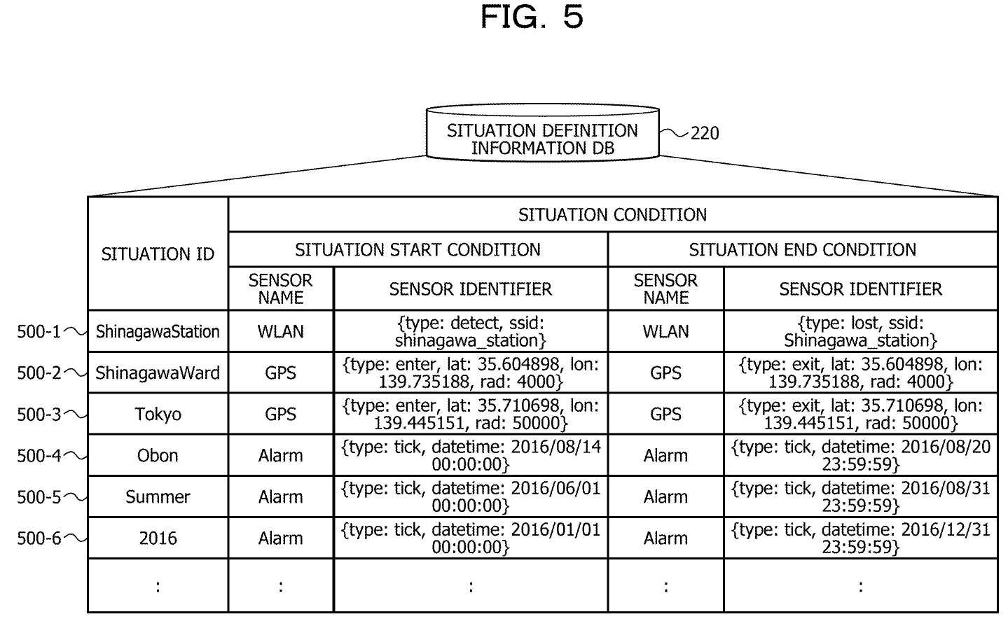

The information processing device 101 includes a situation definition information database (DB) 220 and determines a manner of displaying applications. Contents stored in the situation definition information DB 220 will be described later with reference to FIG. 5. Examples of the information processing device 101 include a smartphone, a cellular phone, a tablet personal computer (PC), and a personal handy-phone system (PHS).

The information processing device 101 may be connected with the network 210 through the access point AP. The access point AP is, for example, an access point installed for a wireless LAN or Bluetooth (registered trademark). The information processing device 101 has a positioning function based on radio waves from a plurality of positioning satellites ST (FIG. 2 illustrates only one of the positioning satellites ST).

In the following description, the positioning satellites ST are, for example, global positioning system (GPS) satellites. However, the positioning satellites ST may be, for example, satellites of a quasi-zenith satellite system.

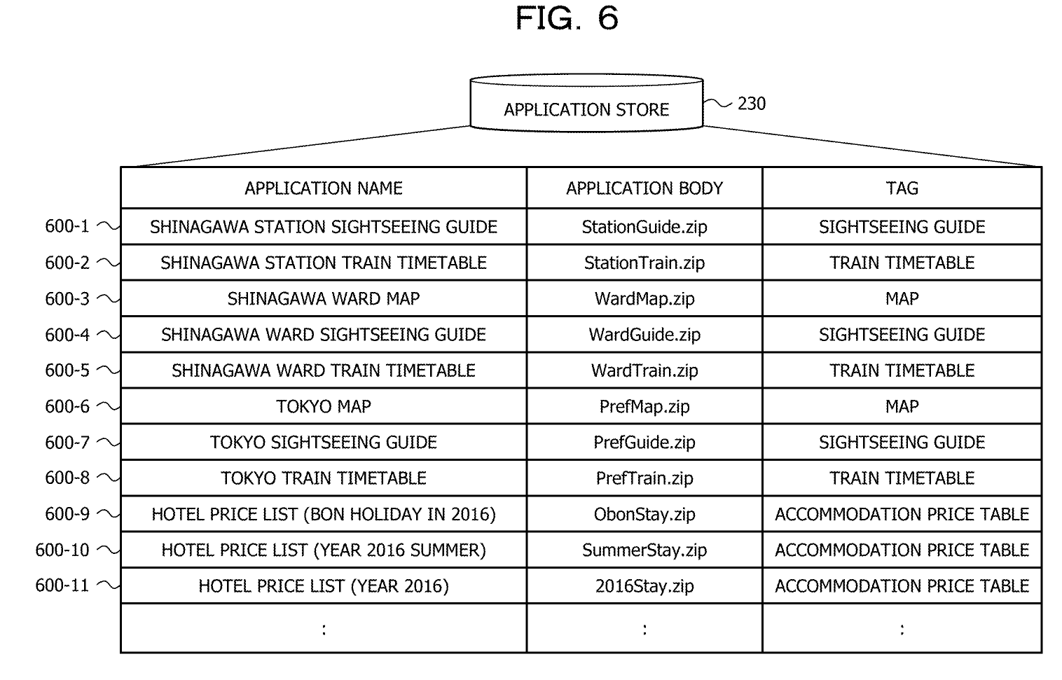

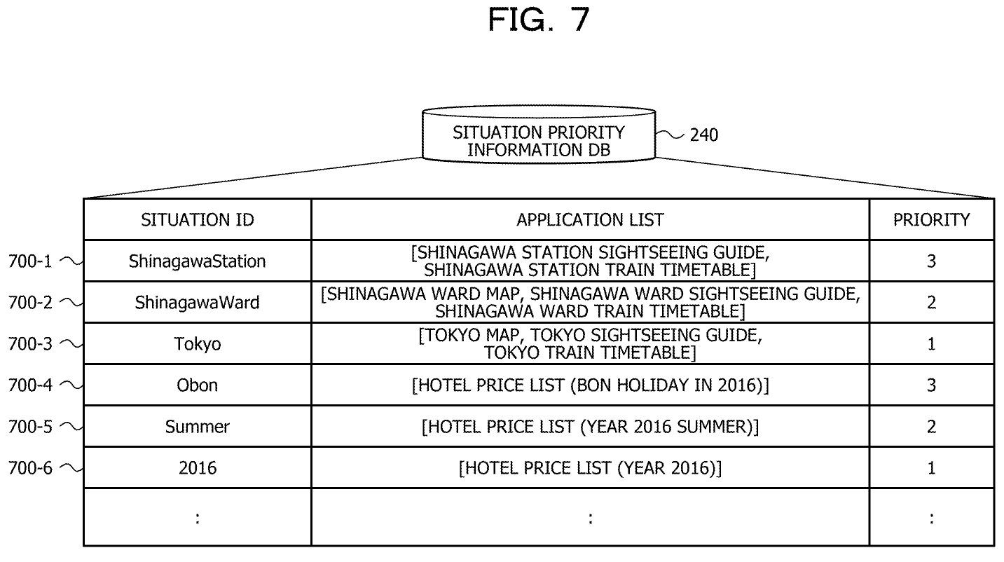

The server 201 is a computer including an application store 230 and a situation priority information DB 240 and configured to distribute an application. Contents stored in the application store 230 and the situation priority information DB 240 will be described later with reference to FIGS. 6 and 7. The information providing device 102 illustrated in FIG. 1 corresponds to, for example, the server 201.

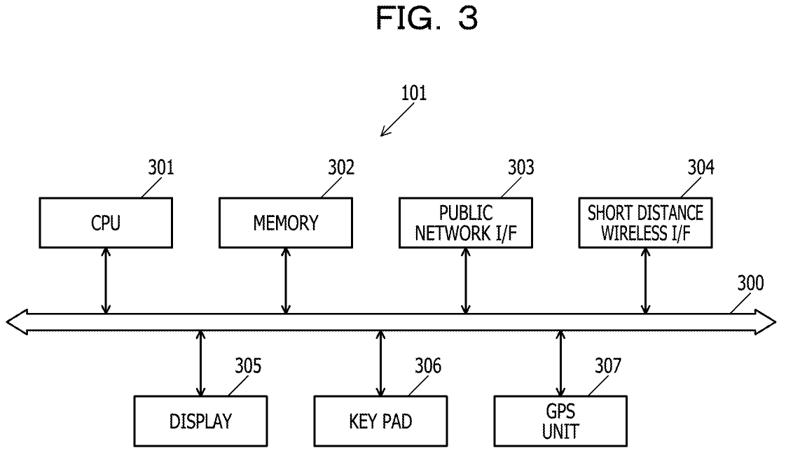

FIG. 3 is a block diagram illustrating an exemplary hardware configuration of the information processing device 101. In FIG. 3, the information processing device 101 includes a central processing unit (CPU) 301, a memory 302, a public network interface (I/F) 303, a short distance wireless I/F 304, a display 305, a key pad 306, and a GPS unit 307. These components are connected with each other through a bus 300.

The CPU 301 governs control of the entire information processing device 101. The memory 302 is achieved by, for example, a read only memory (ROM), a random access memory (RAM), or a flash ROM. Specifically, for example, the flash ROM or the ROM stores various computer programs, and the RAM is used as a work area of the CPU 301. The computer programs stored in the memory 302 are loaded by the CPU 301 to execute processing coded therein through the CPU 301.

The public network I/F 303 includes a wireless communication circuit and an antenna, and is connected with the network 210 and then connected with any other computer (for example, the server 201 illustrated in FIG. 2) through the network 210. The public network I/F 303 serves as an interface between the network 210 and the inside of the device, and controls inputting and outputting of data from any other computer.

The short distance wireless I/F 304 includes a wireless communication circuit and an antenna, and is connected with a wireless network and then connected with any other computer (for example, the access point AP illustrated in FIG. 2) through the wireless network. The short distance wireless I/F 304 serves as an interface between the wireless network and the inside of the device, and controls inputting and outputting of data from any other computer.

The display 305 displays a cursor, an icon, and a tool box, and data such as a document, an image, and function information. Examples of the display 305 include a liquid crystal display and an organic electroluminescence (EL) display. The display screen 120 illustrated in FIG. 1 corresponds to, for example, the display 305.

The key pad 306 includes a key for inputting, for example, characters, numbers, and various instructions, and performs inputting of data. Examples of the key pad 306 include a touch-panel input pad and a numeric keypad.

The GPS unit 307 is a sensor configured to receive radio waves from the positioning satellites ST and output position information indicating the current position of the own device. The position information of the information processing device 101 is information specifying one point on earth, such as a latitude and a longitude. The information processing device 101 may correct position information output from the GPS unit 307 by a differential GPS (DGPS).

The information processing device 101 may include, for example, a disk drive, a disk, and a solid state drive (SSD) in addition to the above-described components. The information processing device 101 may be configured to receive connection of an auxiliary storage device such as a universal serial bus (USB) memory.

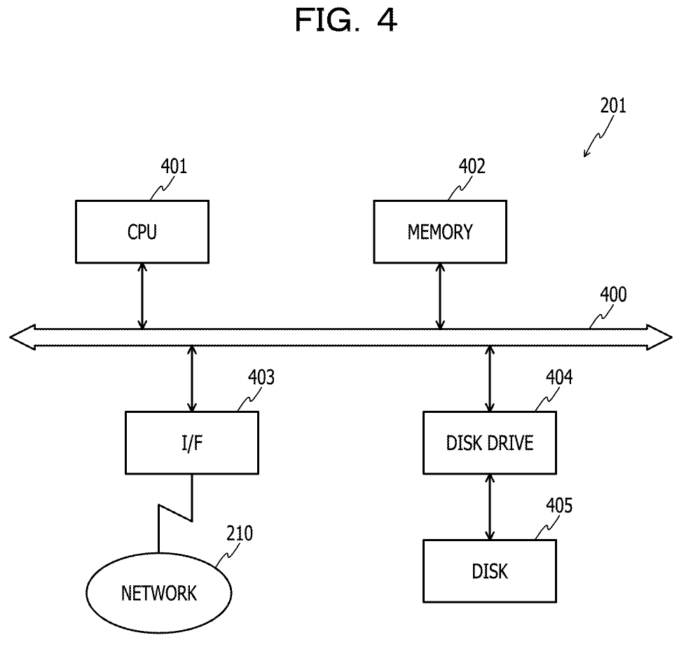

FIG. 4 is a block diagram illustrating an exemplary hardware configuration of the server 201. In FIG. 4, the server 201 includes a CPU 401, a memory 402, an I/F 403, a disk drive 404, and a disk 405. These components are connected with each other through a bus 400.

The CPU 401 governs control of the entire server 201. The memory 402 is achieved by, for example, a ROM, a RAM, and a flash ROM. Specifically, for example, the flash ROM or the ROM stores various computer programs, and the RAM is used as a work area of the CPU 401. The computer programs stored in the memory 402 are loaded by the CPU 401 to execute processing coded therein through the CPU 401.

The I/F 403 is connected with the network 210 through a communication line and then connected with an external computer (for example, the information processing device 101 illustrated in FIG. 2) through the network 210. The I/F 403 serves as an interface between the network 210 and the inside of the device, and controls inputting and outputting of data from an external computer. The I/F 403 may be, for example, a modem or a LAN adapter.

The disk drive 404 controls reading and writing of data from and to the disk 405 under control of the CPU 401. The disk 405 stores data written under control of the disk drive 404. The disk 405 is, for example, a magnetic disk or an optical disk.

The server 201 may include, for example, an SSD, a keyboard, a mouse, and a display in addition to the above-described components. The server 201 may be configured to receive connection of an auxiliary storage device such as a USB memory. The access point AP illustrated in FIG. 2 may be achieved by a hardware configuration same as that of the server 201. When the server 201 is achieved by hardware same as that of the information processing device 101, the server 201 has the exemplarily hardware configuration illustrated in FIG. 3.

The following describes contents stored in the situation definition information DB 220 included in the information processing device 101. The situation definition information DB 220 is achieved by, for example, the memory 302 of the information processing device 101 illustrated in FIG. 3.

FIG. 5 is a diagram (1) illustrating an exemplary stored content of the situation definition information DB 220. In FIG. 5, the situation definition information DB 220 stores situation definition information (for example, situation definition information 500-1 to 500-6) indicating a situation ID and a situation condition in association.

The situation ID is an identifier uniquely identifying a situation. The situation indicates, for example, a place and/or a time. For example, a situation identified by situation ID “ShinagawaStation” indicates a place “Shinagawa Station”. A situation identified by situation ID “2016” indicates a time “Year 2016”.

The situation condition includes a situation start condition and a situation end condition. The situation start condition includes a sensor name and a sensor identifier, and indicates a condition on which a situation indicated by the situation ID starts. The situation end condition includes a sensor name and a sensor identifier, and indicates a condition on which a situation indicated by the situation ID ends, in other words, the situation is left. In other words, the situation end condition is a condition on which the information start condition becomes unsatisfied.

For example, when the sensor name is “WLAN (Wireless LAN)”, “type” and “ssid” are set as sensor identifiers. The identifier “type” is set to “detect” (detected) or “lost” (undetected). The identifier “ssid” is set to a service set identifier (SSID).

Specifically, for example, the situation start condition of the situation definition information 500-1 indicates that the situation identified by situation ID “ShinagawaStation” starts when an access point AP having ssid “Shinagawa_station” is detected. The situation end condition of the situation definition information 500-1 indicates that the situation identified by situation ID “ShinagawaStation” ends when the access point AP having ssid “Shinagawa_station” becomes undetected.

When the sensor name is “GPS”, “type”, “lat”, “lon” and “rad” are set as sensor identifiers. The identifier “type” is set to “enter” (enter a geo-fence) or “exit” (exit the geo-fence). The geo-fence represents a geographical border line (fence) and represents a virtual range set on a map. The identifier “lat” is set to a central coordinate (latitude) of the geo-fence. The identifier “lon” is set to a central coordinate (longitude) of the geo-fence. The identifier “rad” is set to the radius (unit: m) of the geo-fence.

The above describes the example in which a circular range is set as a geo-fence, but, for example, a range having another shape such as a rectangular shape may be set.

Specifically, for example, the situation start condition of the situation definition information 500-2 indicates that a situation identified by situation ID “ShinagawaWard” starts when entry is made into a geo-fence specified by “lat”, “lon”, and “rad”. The situation end condition of the situation definition information 500-2 indicates that the situation identified by situation ID “ShinagawaWard” ends when exit is made from the geo-fence specified by “lat”, “lon”, and “rad”.

When the sensor name is “Alarm”, “type” and “datetime” are set as sensor identifiers. The identifier “type” is set to “tick”. The identifier “datetime” is set to date and time (yyyy/MM/dd tt:mm:ss).

Specifically, for example, the situation start condition of the situation definition information 500-6 indicates that a situation identified by situation ID “2016” starts when the current date and time is within a duration between 00:00:00 on Jan. 1, 2016 and 23:59:59 on Dec. 31, 2016. The end of the duration of the situation start condition is date and time set to a sensor identifier of the situation end condition. The situation end condition of the situation definition information 500-6 indicates that the situation identified by situation ID “2016” ends when the current date and time passes 23:59:59 on Dec. 31, 2016.

The following describes contents stored in the application store 230 included in the server 201. The application store 230 is achieved by, for example, a storage device such as the memory 402 or the disk 405 of the server 201 illustrated in FIG. 4.

FIG. 6 is a diagram (1) illustrating an exemplary stored content of the application store 230. In FIG. 6, the application store 230 includes fields of an application name, an application body, and a tag, and stores application information (for example, application information 600-1 to 600-11) as a record by setting information to each field.

The application name is the name of an application. The application is, for example, a sightseeing application provided by a community, a transportation agency, an accommodation facility, a restaurant, or the like. The application body is an execution file of the application. The tag is information indicating usage of the application. Examples of the usage include a sightseeing guide, a train timetable, a map, and an accommodation price table.

For example, the application information 600-1 includes the application body “StationGuide.zip” and tag “Sightseeing Guide” of an application having an application name of “Shinagawa Station Sightseeing Guide”.

(Contents Stored in Situation Priority Information DB 240)

The following describes contents stored in the situation priority information DB 240 included in the server 201. The situation priority information DB 240 is achieved by, for example, a storage device such as the memory 402 or the disk 405 of the server 201 illustrated in FIG. 4.

FIG. 7 is a diagram (1) illustrating an exemplary stored content of the situation priority information DB 240. In FIG. 7, the situation priority information DB 240 includes fields of a situation ID, an application list, and a priority, and stores situation priority information (for example, situation priority information 700-1 to 700-6) as a record by setting information to each field.

The situation ID is an identifier uniquely identifying a situation indicating a place or a time. The application list is information listing the names of applications for respective usages corresponding to the situation indicated by the situation ID. The priority is a priority applied to each application on the application list and set based on an inclusive relation of a condition (situation start condition) on which the situation indicated by the situation ID starts with another condition that is satisfied simultaneously in some cases.

For example, the situation priority information 700-1 indicates the application names “Shinagawa Station Sightseeing Guide” and “Shinagawa Station train timetable” of applications for respective usages corresponding to the situation identified by situation ID “ShinagawaStation”, and the priority “3” applied to each application.

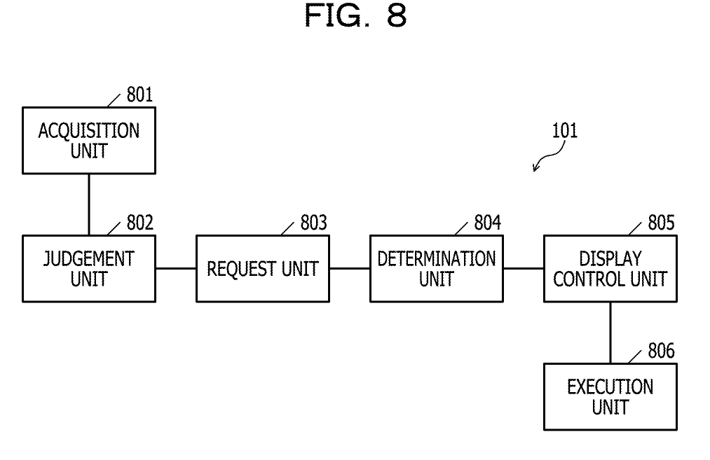

FIG. 8 is a block diagram illustrating an exemplary functional configuration of the information processing device 101. In FIG. 8, the information processing device 101 includes an acquisition unit 801, a judgement unit 802, a request unit 803, a determination unit 804, a display control unit 805, and an execution unit 806. The acquisition unit 801 to the execution unit 806 achieve functions of a control unit. Specifically, the functions are achieved, for example, by the CPU 301 executing the computer programs stored in the memory 302 illustrated in FIG. 3, or by the public network I/F 303 or the short distance wireless I/F 304. A result of processing at each functional component is stored in, for example, the memory 302.

The acquisition unit 801 acquires observation information indicating a situation. The observation information is information indicating the position of the information processing device 101 and date and time. For example, the observation information includes a latitude and a longitude indicating the current position of the information processing device 101, the position of which is detected by using the GPS unit 307 illustrated in FIG. 3.

Specifically, for example, the acquisition unit 801 periodically acquires the observation information including the latitude and longitude illustrating the current position of the own device by acquiring position information output from the GPS unit 307 at a predetermined time interval. The predetermined time interval may be optionally set to be, for example, several minutes to several tens of minutes approximately.

For example, the observation information includes information indicating date and time measured by a time measuring function of the information processing device 101. Specifically, for example, the acquisition unit 801 periodically acquires the observation information including the current date and time by acquiring, at a predetermined time interval, the current date and time measured by time measuring function of the own device.

For example, the observation information includes identification information identifying an access point AP and a Bluetooth low energy (BLE) instrument (not illustrated) that are capable of performing short-distance wireless communication with the information processing device 101. Specifically, for example, upon reception of a beacon signal from the access point AP or the BLE instrument, the acquisition unit 801 acquires the observation information including an SSID contained in this beacon signal.

The judgement unit 802 judges the situation of the own device based on the acquired observation information. In other words, the judgement unit 802 judges to which situation a condition satisfied by the acquired observation information corresponds. Specifically, for example, the judgement unit 802 searches the situation definition information DB 220 illustrated in FIG. 5 for situation definition information having a situation start condition satisfied by the acquired observation information. Upon the search of the situation definition information satisfying the situation start condition, the judgement unit 802 judges that a situation indicated by the situation ID of this situation definition information has started.

For example, the observation information includes a latitude and a longitude indicating the current position of the information processing device 101, the position of which is detected by using the GPS unit 307. In this case, the judgement unit 802 judges that a situation start condition is satisfied when the situation start condition has a sensor name of “GPS” and a sensor identifier specifying a geo-fence in which the latitude and longitude of the acquired observation information are included. In other words, the judgement unit 802 searches the situation definition information DB 220 for situation definition information that includes a situation start condition having a sensor name of “GPS” and a sensor identifier specifying a geo-fence in which the current position of the own device is included. For example, when the situation definition information 500-2 is searched, the judgement unit 802 determines that a situation indicated by situation ID “ShinagawaWard” has started.

For example, the observation information includes the SSID of an access point AP of a wireless LAN. In this case, the judgement unit 802 judges that a situation start condition is satisfied when the situation start condition has a sensor name of “WLAN” and a sensor identifier including the SSID of the acquired observation information. In other words, the judgement unit 802 searches the situation definition information DB 220 for situation definition information that includes a situation start condition having a sensor name of “WLAN” and a sensor identifier ssid identical to the SSID of the observation information. For example, the situation definition information 500-1 is searched when the observation information includes SSID “Shinagawa_station”. In this case, the judgement unit 802 judges that a situation indicated by situation ID “ShinagawaStation” has started.

For example, the observation information includes current date and time. In this case, the judgement unit 802 judges that a situation start condition is satisfied when the situation start condition has a sensor name of “Alarm” and a sensor identifier specifying a duration including the current date and time of the acquired observation information. In other words, the judgement unit 802 searches the situation definition information DB 220 for situation definition information that includes a situation start condition having a sensor name of “Alarm” and a sensor identifier specifying a duration including the current date and time of the observation information. For example, the situation definition information 500-6 is searched when the observation information includes a current date and time “2016/01/01 12:34:56”. In this case, the judgement unit 802 judges that a situation indicated by situation ID “2016” has started.

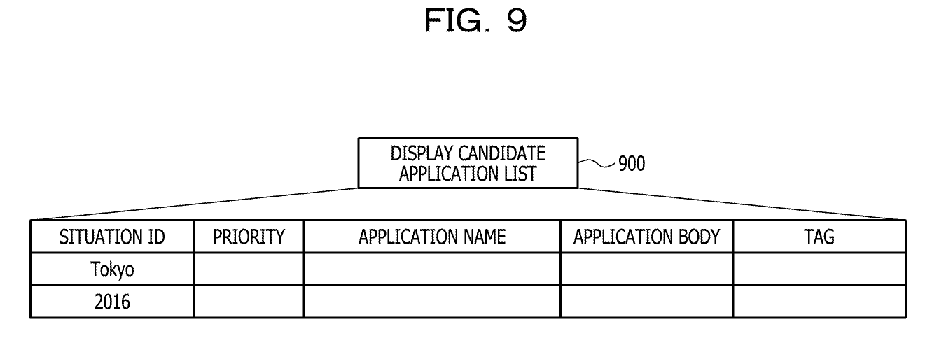

A situation ID indicating the judged situation of the own device is registered in, for example, a display candidate application list 900 as illustrated in FIG. 9. The display candidate application list 900 is stored in, for example, the memory 302.

FIG. 9 is a diagram (1) illustrating an exemplary stored content of the display candidate application list 900. In FIG. 9, the display candidate application list 900 stores, in association with a situation ID, the application name and application body of a display candidate application to which a priority and a tag are applied. The situation ID is an identifier uniquely identifying a situation indicating a place or a time.

The priority is a priority applied to the display candidate application and set based on an inclusive relation of a condition (situation start condition) on which the situation indicated by the situation ID starts with another condition that is simultaneously satisfied in some cases. The application name is the name of the display candidate application. The application body is an execution file of the display candidate application. The tag indicates usage of the display candidate application. In the example illustrated in FIG. 9, only the situation ID is set.

In FIG. 8, the request unit 803 acquires an application corresponding to the judged situation of the own device. Specifically, for example, the request unit 803 transmits, to the server 201, a distribution request including a situation ID registered in the display candidate application list 900 illustrated in FIG. 9. This situation ID indicates the situation of the information processing device 101. However, an application, the application body of which is already registered in the display candidate application list 900, is excluded as a request target application.

Then, as a result of transmission of the distribution request, the request unit 803 acquires application information corresponding to the situation of the own device through reception from the server 201. The application information includes, for example, the application body and application name of an application corresponding to the situation ID included in the distribution request, and a priority and a tag applied to this application.

The application body, the priority, and the tag included in the acquired application information are stored in the display candidate application list 900 in association with the corresponding situation ID. This completes acquisition of an application that corresponds to the situation of the information processing device 101 and to which a priority based on an inclusive relation between this situation and another situation, and a tag indicating a usage are applied.

The judgement unit 802 judges whether the situation end condition of a situation corresponding to the acquired application is satisfied based on the acquired observation information. In other words, the judgement unit 802 judges whether a situation start condition corresponding to any acquired application has become unsatisfied based on the acquired observation information. Then, when it is judged that the situation end condition is satisfied, the judgement unit 802 deletes this application. Specifically, for example, the judgement unit 802 judges, by referring to the situation definition information DB 220, whether the acquired observation information satisfies the situation end condition of situation definition information corresponding to any situation ID in the display candidate application list 900.

For example, the observation information include a latitude and a longitude indicating the current position of the information processing device 101, the position of which is detected by using the GPS unit 307. In this case, the judgement unit 802 judges that a situation end condition is satisfied when the situation end condition has a sensor name of “GPS” and a sensor identifier specifying a geo-fence in which the current position of the own device indicated by the latitude and longitude of the observation information is not included. Then, the judgement unit 802 deletes, from the display candidate application list 900, records (a situation ID, a priority, an application body, and a tag) corresponding to the situation ID of the satisfied situation end condition.

For example, the observation information includes the SSID of an access point AP of a wireless LAN. In this case, the judgement unit 802 judges that a situation end condition is satisfied when the situation end condition has a sensor name of “WLAN” and a sensor identifier not including the SSID of the acquired observation information. Then, the judgement unit 802 deletes, from the display candidate application list 900, records (a situation ID, a priority, an application body, and a tag) corresponding to the situation ID of the satisfied situation end condition.

For example, the observation information includes current date and time. In this case, the judgement unit 802 judges that a situation end condition is satisfied when the situation end condition has a sensor name of “Alarm” and a sensor identifier specifying date and time earlier than the current date and time of the acquired observation information. Then, the judgement unit 802 deletes, from the display candidate application list 900, records (a situation ID, a priority, an application body, and a tag) corresponding to the situation ID of the satisfied situation end condition.

In this manner, the end of a situation judged as the situation of the own device may be detected, and an application corresponding to the ended situation may be deleted as a display candidate application.

The determination unit 804 determines one or a plurality of applications based on acquired priorities thereof. Specifically, for example, the determination unit 804 compares the priorities of display candidate applications by referring to the display candidate application list 900. Then, the determination unit 804 may determine, based on a result of the comparison, a display manner in which N display candidate applications having highest priorities are displayed in a predetermined order.

In other words, among display candidate applications in the display candidate application list 900, any display candidate application other than the N display candidate applications having highest priorities is not displayed. The number N may be optionally set to, for example, a value of 1 to 10 approximately. The predetermined order is, for example, descending order of priority, Japanese alphabetical order of application names, or alphabetical order thereof.

For example, the determination unit 804 may compare the priorities of applications for an identical usage based on acquired tags of one or a plurality of applications, and determine applications for each usage based on a result of the comparison. Specifically, for example, the determination unit 804 categorizes display candidate applications for each tag by referring to the display candidate application list 900. Then, the determination unit 804 compares the priorities of the categorized display candidate applications for each tag.

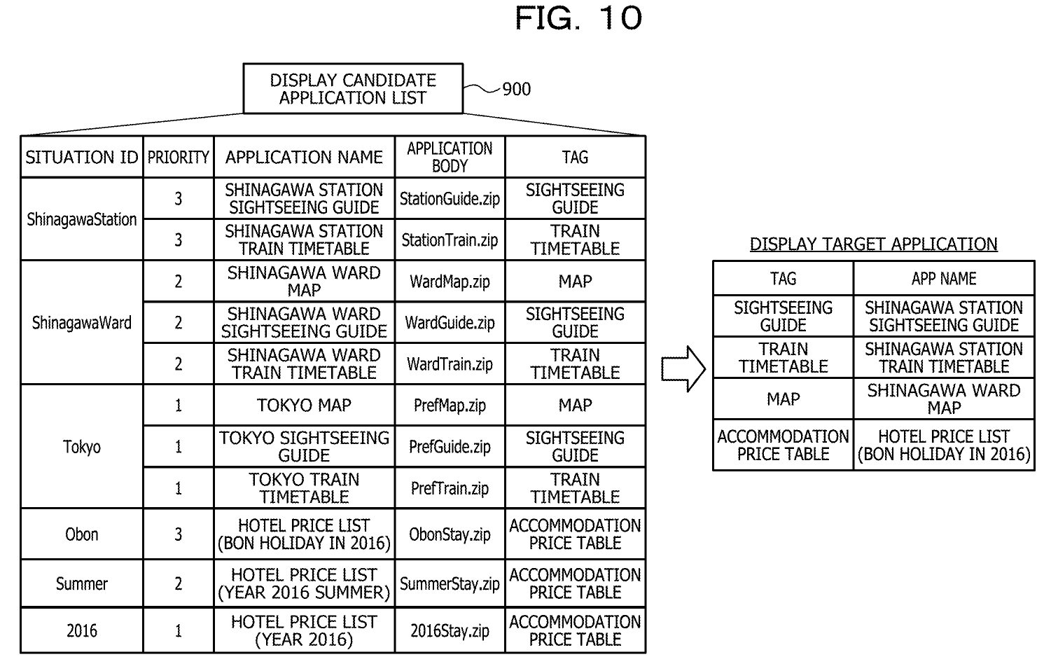

Then, the determination unit 804 extracts N display candidate applications having highest priorities for each tag based on a result of the comparison. Then, the determination unit 804 may determine a display manner in which the N display candidate applications having highest priorities and extracted for each tag are displayed in a predetermined order. The following describes exemplary application determination with reference to FIG. 10.

FIG. 10 is a diagram illustrating the exemplary application determination. In FIG. 10, the display candidate application list 900 stores, in association with a situation ID, the application name and application body of a display candidate application to which a priority and a tag are applied.

In the example illustrated in FIG. 10, the determination unit 804 categorizes display candidate applications for each tag, for example, by referring to the display candidate application list 900. In this example, the display candidate applications are categorized for each tag of “Sightseeing Guide”, “Train Timetable”, “Map”, and “Accommodation Price Table”.

Then, the determination unit 804 compares the priorities of the categorized display candidate applications for each tag. For example, in a case of the tag “Map”, the determination unit 804 compares the priority “2” of a display candidate application having an application name of “WardMap.zip” and the priority “1” of a display candidate application having an application name of “PrefMap.zip”.

Then, the determination unit 804 extracts a display candidate application having the highest priority for each tag based on a result of the comparison (the number N=1). Then, the determination unit 804 determines the display candidate application having the highest priority and extracted for each tag to be a display target application. In the example illustrated in FIG. 10, display candidate applications having application names of “Shinagawa Station Sightseeing Guide”, “Shinagawa Station train timetable”, “Shinagawa Ward map”, and “hotel price list (Bon holiday in 2016)” are determined to be display target applications for the respective tags.

In FIG. 8, the display control unit 805 performs control of displaying one or a plurality of determined applications. Specifically, for example, the display control unit 805 performs control of displaying an application determined for each usage.

More specifically, for example, a display candidate application having the highest priority for each usage (tag) is determined to be a display target application. In this case, the display control unit 805 extracts an icon image from the application body of the display target application, and generates screen information of an application list screen including the extracted icon image. Then, the display control unit 805 may display the application list screen on the display 305 illustrated in FIG. 3 based on the generated screen information.

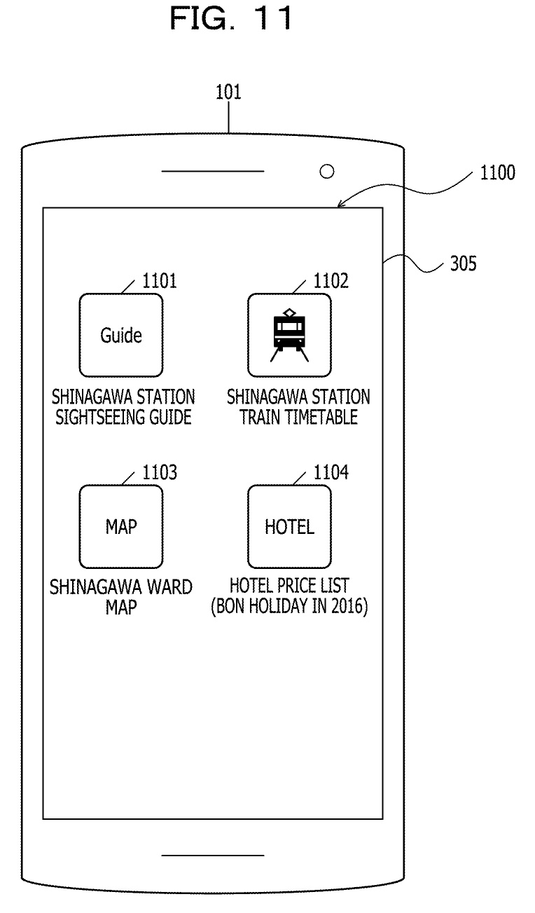

The following describes an exemplary application list screen with reference to FIG. 11.

FIG. 11 is a diagram illustrating the exemplary application list screen. In FIG. 11, icon images 1101 to 1104 are displayed on an application list screen 1100. The icon images 1101 to 1104 are icon images of applications having the highest priorities for respective usages (tags).

Specifically, the icon image 1101 is an icon image of display candidate application “Shinagawa Station Sightseeing Guide” having the highest priority among display candidate applications having tag “Sightseeing Guide” in the display candidate application list 900 illustrated in FIG. 10. The icon image 1102 is an icon image of display candidate application “Shinagawa Station train timetable” having the highest priority among display candidate applications having tag “Train Timetable” in the display candidate application list 900.

The icon image 1103 is an icon image of display candidate application “Shinagawa Ward map” having the highest priority among display candidate applications having tag “Map” in the display candidate application list 900. The icon image 1104 is an icon image of display candidate application “hotel price list (Bon holiday in 2016)” having the highest priority among display candidate applications having tag “Accommodation Price Table” in the display candidate application list 900.

In the application list screen 1100, a reduced number of icon images are displayed to reduce display complication, which allows the user to easily specify, for each usage, an application suitable for the current situation. The icon images 1101 to 1104 may be each displayed together with information that allows determination of usage of an application, for example, a character string indicating usage.

In FIG. 8, the execution unit 806 executes an application. Specifically, for example, in response to selection of any icon image on the application list screen 1100 as illustrated in FIG. 11, the execution unit 806 executes an application (application body) corresponding to the selected icon image.

For example, when the icon image 1101 is selected on the application list screen 1100 through an operation input by the user, the application “Shinagawa Station Sightseeing Guide” is executed based on the application body “StationGuide.zip” corresponding to the icon image 1101.

Although the above description is made on the exemplary case based on the assumption that nearby information is more valuable to the user, far information is more valuable in some cases. For example, when the user is currently in Shinagawa Ward but about to move to another ward, a map of Tokyo provided by Tokyo is more requested than a map of Shinagawa Ward provided by Shinagawa Ward in some cases.

This case occurs depending on whether the user is focused on a place where the user currently is or any other place. Thus, the information processing device 101 may estimate that the user is intended to move when the current place is not a place in which the user is predicted to be in near future, and may lower the priorities of applications currently displayed.

Specifically, for example, the information processing device 101 may presume a position at which the user is predicted to be after a certain time (for example, after 30 minutes) based on the recent moving speed of the user and the current moving direction thereof. Then, when the presumed position is not the current place, the information processing device 101 may judge that information on the current place is not much valuable, may and lower the priority of any application corresponding to the current place and determine applications again. In this case, instead of ending display of the application having a lowered priority at this timing, the information processing device 101 may end the display at a timing when the user has left the current place.

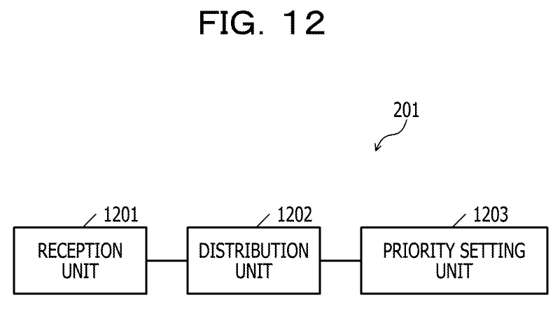

FIG. 12 is a block diagram illustrating an exemplary functional configuration of the server 201. In FIG. 12, the server 201 includes a reception unit 1201, a distribution unit 1202, and a priority setting unit 1203. The reception unit 1201 to the priority setting unit 1203 achieve functions of a control unit. Specifically, for example, the functions are achieved by the CPU 401 executing the computer programs stored in a storage device such as the memory 402 or the disk 405 illustrated in FIG. 4, or by the I/F 403. A result of processing at each functional component is stored in, for example, the storage device such as the memory 402 or the disk 405.

The reception unit 1201 receives a situation ID indicating the situation of the information processing device 101. Specifically, for example, through reception of a distribution request from the information processing device 101, the reception unit 1201 receives a situation ID included in the received distribution request.

The distribution unit 1202 distributes an application corresponding to the received situation ID indicating the situation of the information processing device 101. Specifically, for example, the distribution unit 1202 extracts, from the situation priority information DB 240 illustrated in FIG. 7, situation priority information corresponding to the situation ID included in the received distribution request. Then, the distribution unit 1202 acquires, from the application store 230 illustrated in FIG. 6, an application body and a tag corresponding to an application name in an application list of the extracted situation priority information.

Then, the distribution unit 1202 transmits, to the information processing device 101, application information including the priority of the situation priority information, the acquired tag, and the application body in association with the situation ID of the extracted situation priority information. Accordingly, the information processing device 101 may receive distribution of an application that corresponds to the situation of the information processing device 101 and to which a priority based on an inclusive relation between this situation and any other situation and a tag indicating usage are applied.

The priority setting unit 1203 sets a priority corresponding to a condition related to a situation based on an inclusive relation of the condition with another condition that is simultaneously satisfied in some cases. In the following description, a “condition” is referred to as a “situation” in some cases. Specifically, for example, the priority setting unit 1203 produces a tree structure by estimating an inclusive relation between situations (conditions), and sets a priority based on the height of a node representing each situation.

For example, assume a case in which a situation indicates a place. In this case, the priority setting unit 1203 produces a tree structure of place names from, for example, an address database. Then, the priority setting unit 1203 sets a priority to each node so that a priority at a level is higher in ascending order from a node at the top level to a node at the bottom level.

Accordingly, when a situation indicates a place, a higher priority is set to a node representing a situation with a smaller area, in other words, with a narrower place. As a result, when a situation indicates a place, a higher priority may be applied to an application corresponding to a situation with a smaller area, in other words, with a narrower place.

The user wants to add a place not in the address database in some cases. In this case, user defined information indicating the place may be input through, for example, an operation input from the user by using the key pad 306 illustrated in FIG. 3. The user defined information includes, for example, information indicating the place name, position (latitude and longitude), and range (radius) of the place.

In this case, the priority setting unit 1203 produces a tree structure of place names based on, for example, the address database, and converts each place name into real numbers based on, for example, a map database. More specifically, for example, the priority setting unit 1203 converts the name of a place indicated by each node into real numbers indicating the position (latitude and longitude) of the center point of the place and the range (radius) thereof.

Then, the priority setting unit 1203 searches the tree structure based on the input user defined information to find which node has an inclusive relation with a node representing a place to be newly added, and adds the new node as a child node of the found node. Then, the priority setting unit 1203 converts the real number of each node of the tree structure back into a place name, and sets a priority to the place name based on the height of a node representing each place (situation) as described above.

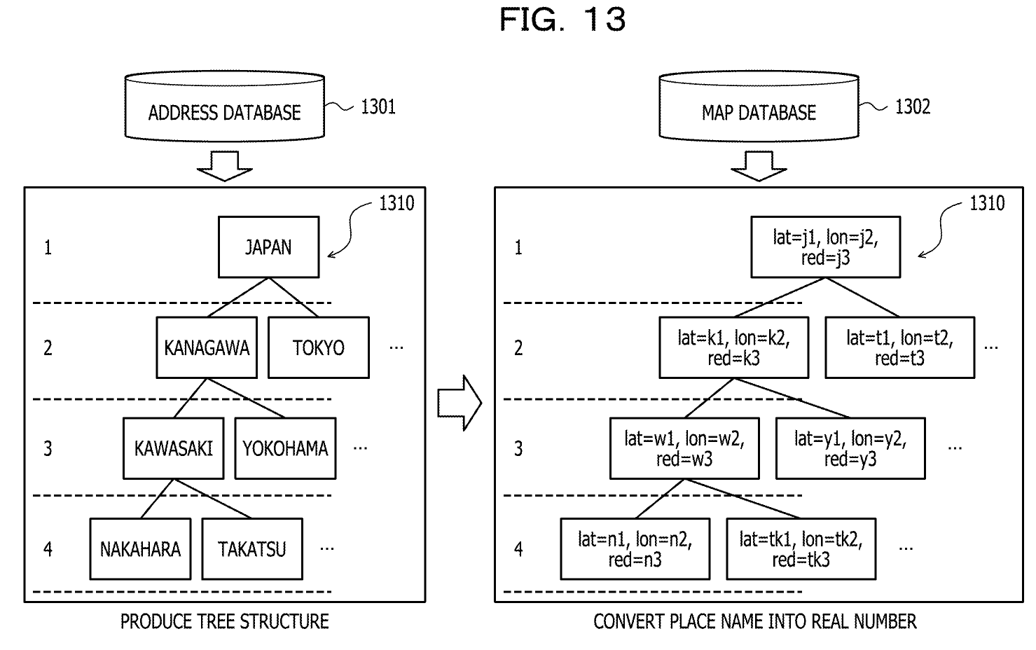

Exemplary setting of a priority corresponding to a situation will be described later with reference to FIG. 13.

The priority setting unit 1203 may register, in association with a situation ID indicating each situation (place), the application name (application list) of any application provided at the situation (place) and a priority corresponding to the situation (place). The situation ID may be optionally set. For example, the situation ID may be an ID defined by the use or a place name.

Situation priority information that provides a higher priority to an application provided at a situation indicating a narrow place may be produced in this manner. However, the processing of registering an application corresponding to a situation ID may be manually performed, for example.

Similarly, situation priority information may be produced when a situation indicates a time. Specifically, for example, the priority setting unit 1203 produces a tree structure of time names based on a dictionary (for example, thesaurus) indicating a level structure of time names. More specifically, for example, the priority setting unit 1203 produces a tree structure with a root node representing twenty-first century, child nodes representing years 2016, 2017, . . . , grandchild nodes representing January, February, . . . , great-grandchild nodes representing days one, two, . . . , and great-great-grandchild nodes representing morning and afternoon. Then, the priority setting unit 1203 sets a priority to each node so that a priority at a level is higher in ascending order from a node at the top level to a node at the bottom level.

Accordingly, when a situation indicates a time, a higher priority is set to a node representing the situation with a shorter time length. As a result, when a situation indicates a time, a higher priority may be applied to an application corresponding to a situation with a shorter time length.

When the user wants to add the name of a time not in the dictionary, user defined information indicating the time may be input through, for example, an operation input from the user. The user defined information includes, for example, information indicating the time name and time length of the time. In this case, the priority setting unit 1203 produces a tree structure of time names based on, for example, a dictionary indicating a level structure of time names, and converts the time name of each node into real numbers.

Then, the priority setting unit 1203 searches the tree structure based on the input user defined information to find which node has an inclusive relation with a node representing a time to be newly added, and adds the new node as a child node of the found node. Then, the priority setting unit 1203 converts the real number of each node of the tree structure back into a time name, and sets a priority to the time name based on the height of a node representing each time (situation) as described above.

In the above description, the information processing device 101 determines the situation of the own device based on acquired observation information, but the present embodiment is not limited thereto. For example, the server 201 may acquire observation information from the information processing device 101 and determine the situation of the information processing device 101.

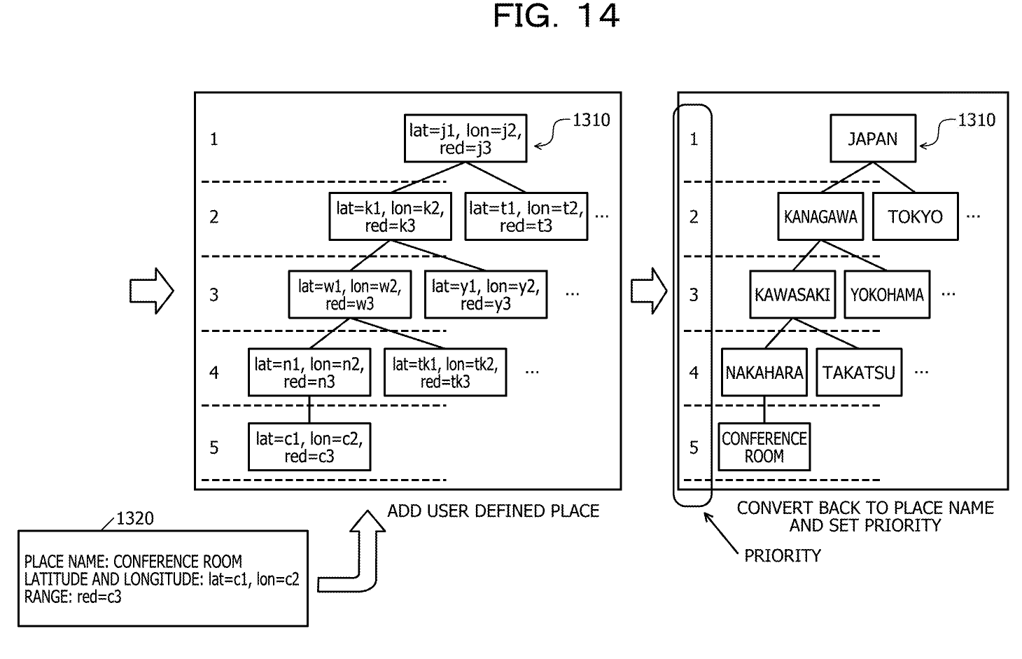

The following describes exemplary setting of a priority corresponding to a situation indicating a place with reference to FIGS. 13 and 14. FIGS. 13 and 14 are each a diagram illustrating the exemplary setting of a priority corresponding to a situation indicating a place.

In FIG. 13, first, the priority setting unit 1203 produces a tree structure 1310 of place names based on an address database 1301. Then, the priority setting unit 1203 converts each place name of the tree structure 1310 into real numbers based on a map database 1302. In this example, the name of a place indicated by each node is converted into real numbers indicating the position (latitude and longitude) of the center point of the place and the range (radius) thereof.

In FIG. 14, assume a case in which user defined information 1320 is input through an operation input from the user. The user defined information 1320 includes information indicating the place name “Conference Room”, position (latitude and longitude), and range (radius) of a place.

In this case, the priority setting unit 1203 searches the tree structure 1310 based on the user defined information 1320 to find which node has an inclusive relation with a node representing a place to be newly added, and adds the new node as a child node of the found node. In the example illustrated in FIG. 14, a node representing real numbers of place name “Conference Room” indicated by the user defined information 1320 is added as a child node of a node representing real numbers of place name “Nakahara”.

Then, the priority setting unit 1203 converts real numbers of each node of the tree structure back into a place name, and sets a priority based on the height of a node representing each place (situation). In the example illustrated in FIG. 14, for example, priority “1” is set to a node representing place name “Japan” at the top level. Then, priority “5” is set to a node representing place name “Conference Room” at the bottom level.

Accordingly, for example, priority “1” is set to a situation indicating place name “Japan”, and priority “5” is set to a situation indicating place name “Conference Room”. In this manner, a higher priority may be applied to an application corresponding to a situation with a smaller area.

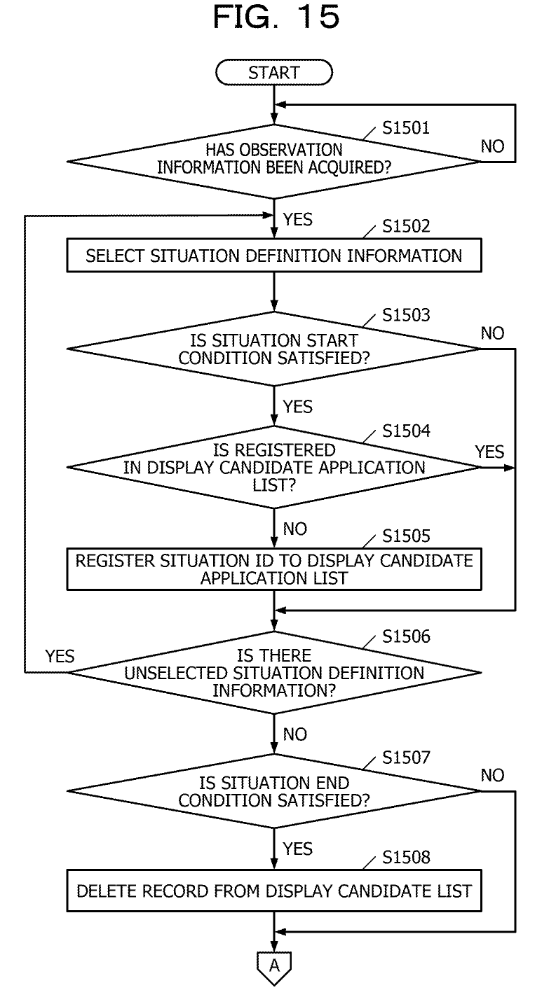

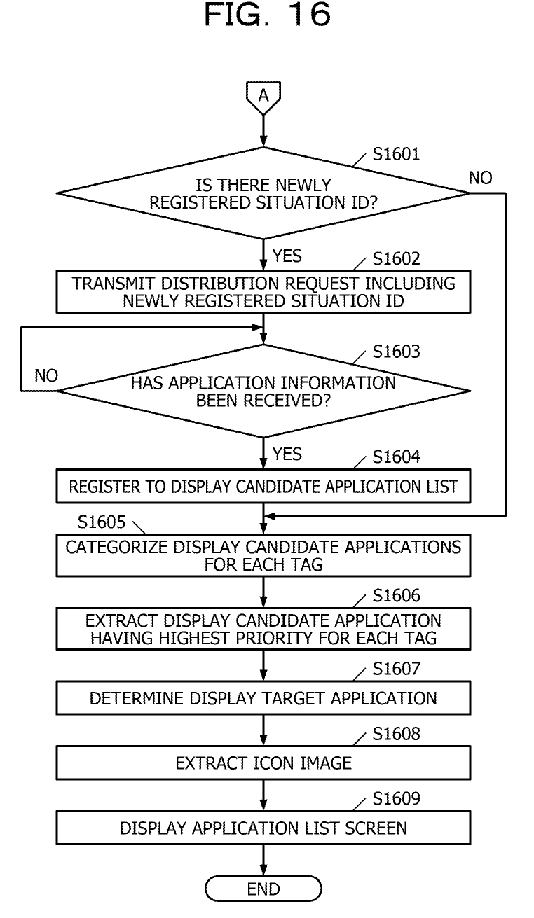

The following describes a procedure of display control processing at the information processing device 101 with reference to FIGS. 15 and 16.

FIGS. 15 and 16 are each a flowchart of an exemplary procedure of the display control processing at the information processing device 101. In the flowchart illustrated in FIG. 15, first, the information processing device 101 judges whether observation information has been acquired (S1501). The information processing device 101 waits acquisition of the observation information (No at S1501).

Then, when having acquired the observation information (Yes at S1501), the information processing device 101 selects unselected situation definition information in the situation definition information DB 220 (S1502). Then, the information processing device 101 judges whether the acquired observation information satisfies the situation start condition of the selected situation definition information (S1503).

When the situation start condition is not satisfied (No at S1503), the information processing device 101 proceeds to S1506. When the situation start condition is satisfied (Yes at S1503), the information processing device 101 judges whether the situation ID of the selected situation definition information is registered in the display candidate application list 900 (S1504).

When the situation ID is registered in the display candidate application list 900 (Yes at S1504), the information processing device 101 proceeds to S1506. When the situation ID is not registered in the display candidate application list 900 (No at S1504), the information processing device 101 registers the situation ID of the selected situation definition information to the display candidate application list 900 (S1505).

Then, the information processing device 101 judges whether there is unselected situation definition information in the situation definition information DB 220 (S1506). When there is unselected situation definition information (Yes at S1506), the information processing device 101 returns to S1502.

When there is no unselected situation definition information (No at S1506), the information processing device 101 judges, by referring to the situation definition information DB 220, whether the acquired observation information satisfies the situation end condition of situation definition information corresponding to any situation ID in the display candidate application list 900 (S1507).

When the situation end condition is not satisfied (No at S1507), the information processing device 101 proceeds to S1601 illustrated in FIG. 16. When the situation end condition is satisfied (Yes at S1507), the information processing device 101 deletes, from the display candidate application list 900, records (a situation ID, a priority, an application body, and a tag) corresponding to a situation ID, the situation end condition of which is satisfied (S1508), and then proceeds to S1601 illustrated in FIG. 16.

In the flowchart illustrated in FIG. 16, first, the information processing device 101 judges whether there is a situation ID newly registered to the display candidate application list 900 at S1505 illustrated in FIG. 15, (S1601). A newly registered situation ID is a situation ID to which a priority, an application body, and a tag are not set.

When there is no newly registered situation ID (No at S1601), the information processing device 101 proceeds to S1605. When there is a newly registered situation ID (Yes at S1601), the information processing device 101 transmits, to the server 201, a distribution request including the situation ID newly registered to the display candidate application list 900 (S1602).

Then, the information processing device 101 judges whether application information in accordance with the distribution request has been received from the server 201 (S1603). The information processing device 101 waits reception of the application information (No at S1603). Then, when having received the application information (Yes at S1603), the information processing device 101 registers an application body, a priority, and a tag included in the received application information to the display candidate application list 900 in association with the corresponding situation ID (S1604).

Then, the information processing device 101 categorizes display candidate applications for each tag by referring to the display candidate application list 900, (S1605). Then, the information processing device 101 extracts a display candidate application having the highest priority for each tag based on a result of comparison of the priorities of the categorized display candidate applications (S1606). In the example illustrated in FIG. 10, display candidate applications having the highest priority are extracted for each tag.

Then, the information processing device 101 determines, to be a display target application, the display candidate application having the highest priority and extracted for each tag (S1607), and extracts an icon image from the application body of the determined display target application (S1608). Then, the information processing device 101 displays, on the display 305, an application list screen including the extracted icon image (S1609), which ends the series of processing in the present flowchart.

Accordingly, the information processing device 101 may display, on the display 305, an application list screen in which a display candidate application having the highest priority for each tag (usage) among the display candidate applications in the display candidate application list 900 is displayed in a list.

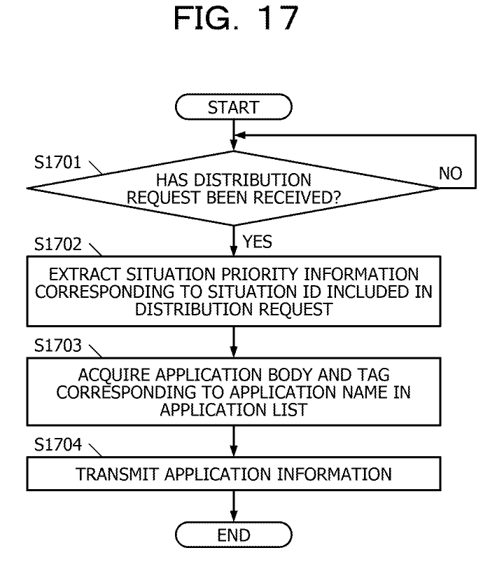

The following describes processes of various pieces of processing at the server 201. First, the procedure of distribution processing at the server 201 will be described below with reference to FIG. 17.

FIG. 17 is a flowchart of an exemplary procedure of the distribution processing at the server 201. In the flowchart illustrated in FIG. 17, first, the server 201 whether a distribution request has been received from the information processing device 101 determines (S1701). The server 201 waits reception of the distribution request (No at S1701).

Then, when having received the distribution request (Yes at S1701), the server 201 extracts, from the situation priority information DB 240, situation priority information corresponding to a situation ID included in the received distribution request (S1702). Then, the server 201 acquires, from the application store 230, an application body and a tag corresponding to an application name in an application list of the extracted situation priority information (S1703).

Then, the server 201 transmits application information including the priority of the situation priority information and the acquired tag and application body to the information processing device 101 in association with the situation ID of the extracted situation priority information (S1704), which ends the series of processing in the present flowchart. In this manner, the server 201 may distribute an application corresponding to the situation of the information processing device 101.

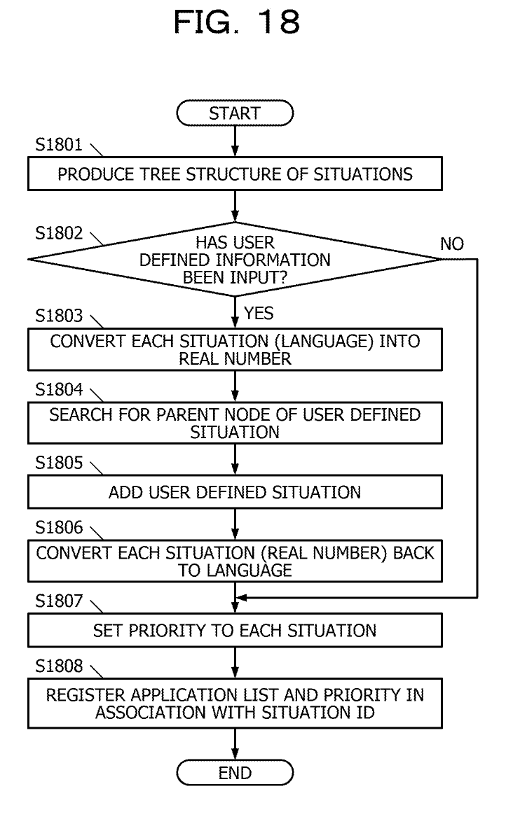

The following describes the procedure of priority setting processing at the server 201 with reference to FIG. 18.

FIG. 18 is a flowchart of an exemplary procedure of the priority setting processing at the server 201. In the flowchart illustrated in FIG. 18, first, the server 201 produces a tree structure by estimating an inclusive relation between situations (S1801). A situation corresponds to a condition related to a place or a time. Then, the server 201 judges whether user defined information has been input (S1802).

When no user defined information has been input (No at S1802), the server 201 proceeds to S1807. When the user defined information has been input (Yes at S1802), the server 201 converts each situation (language) of the tree structure into real numbers (S1803).

Then, the server 201 searches, based on the input user defined information, the tree structure for a parent node having an inclusive relation with a node representing a user defined situation (S1804). Then, the server 201 adds the node representing the user defined situation as a child node of the searched parent node (S1805).

Then, the server 201 converts each situation (real numbers) of the tree structure back into a language (S1806), and sets a priority to each situation based on the height of a node representing the situation in the tree structure (S1807). Then, the server 201 registers, in association with a situation ID indicating the situation, an application list of applications provided in the situation and a priority corresponding to the situation (S1808), which ends the series of processing in the present flowchart.

In this manner, the server 201 may set, to each situation (condition), a priority based on an inclusive relation between the situation and another situation.

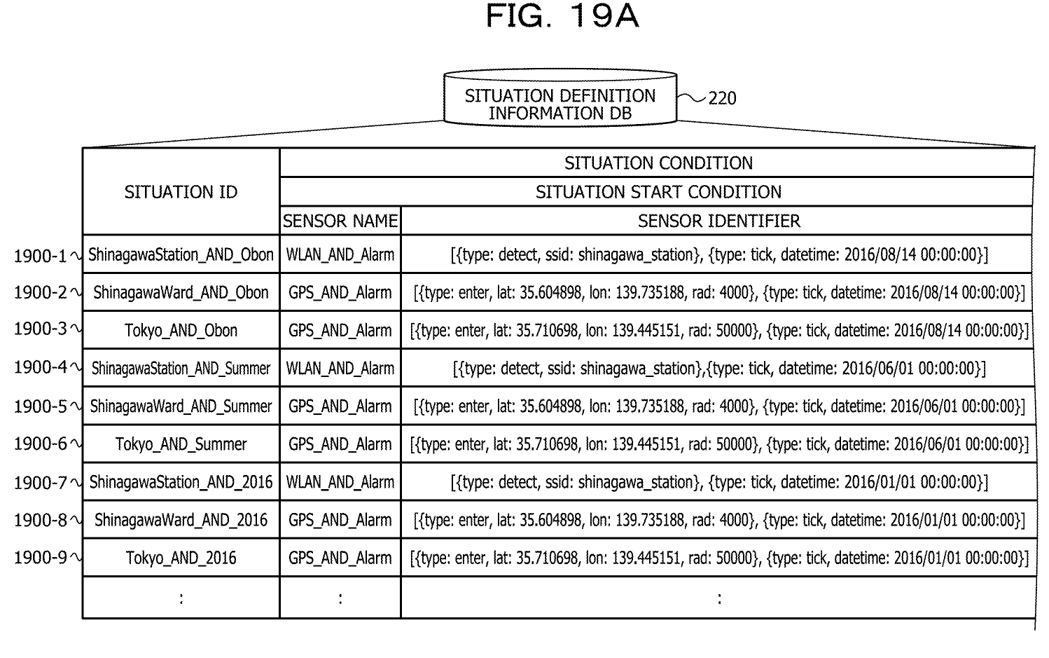

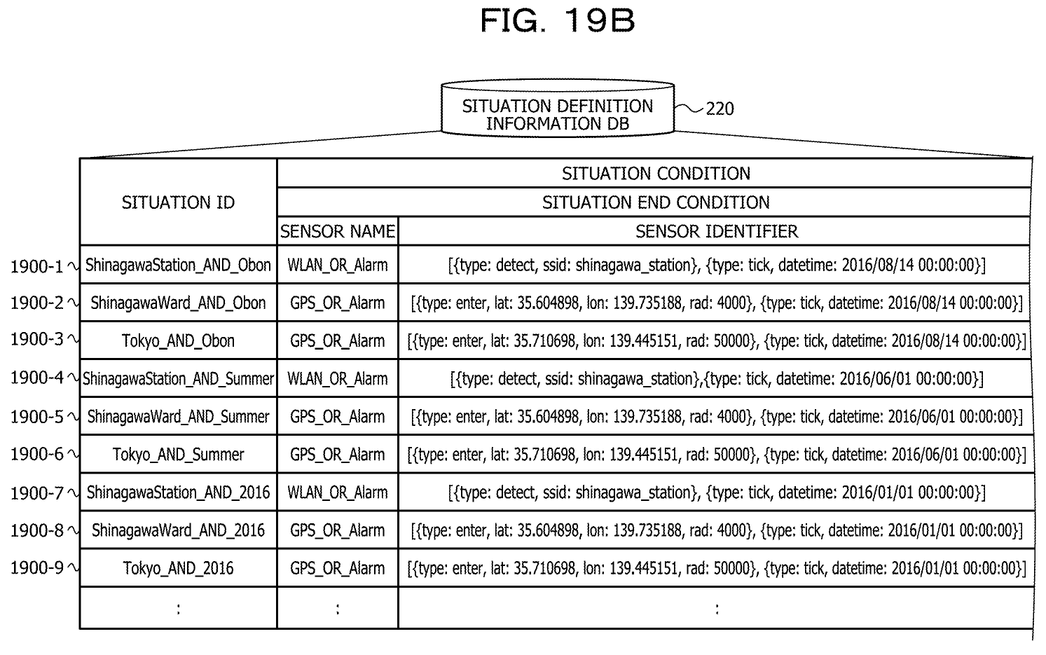

In the example of the situation definition information DB 220 illustrated in FIG. 5, a situation indicates “a place or a time”. However, when a situation indicates “a place and a time”, the situation definition information DB 220 stores, for example, contents as illustrated in FIGS. 19A and 19B.

FIGS. 19A and 19B are each a diagram illustrating exemplary contents stored in the situation definition information DB 220. In FIGS. 19A and 19B, the situation definition information DB 220 stores situation definition information (for example, situation definition information 1900-1 to 1900-9) indicating a situation ID and a situation condition in association. The example of situation start conditions are describe in FIG. 19A and the situation end conditions are described in FIG. 19B.

When a situation indicates “a place and a time”, the situation start condition is defined as a logical expression connecting a condition related to a place and a condition related to a time with each other through “AND”. In other words, the situation start condition is satisfied when the condition related to a place and the condition related to a time are both satisfied. The situation end condition is defined as a logical expression connecting a condition related to a place and a condition related to a time with each other through “OR”. In other words, the situation end condition is satisfied when any of the condition related to a place and the condition related to a time is satisfied.

For example, the situation start condition of the situation definition information 1900-1 indicates that a situation identified by situation ID “ShinagawaStation_AND_Obon” starts when the access point AP having ssid “Shinagawa_station” is detected and the current date and time is within a duration between 00:00:00 on Aug. 14, 2016 and 23:59:59 on Aug. 20, 2016. The situation end condition of the situation definition information 1900-1 indicates that the situation identified by situation ID “ShinagawaStation_AND_Obon” ends when the access point AP having ssid “Shinagawa_station” has become undetected or the current date and time has passed 23:59:59 on Aug. 20, 2016.

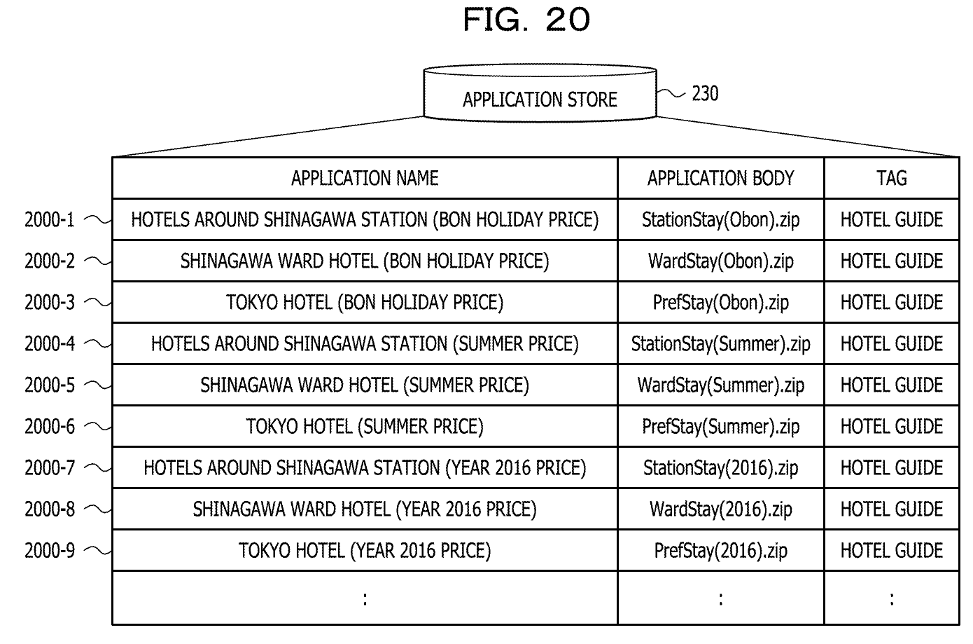

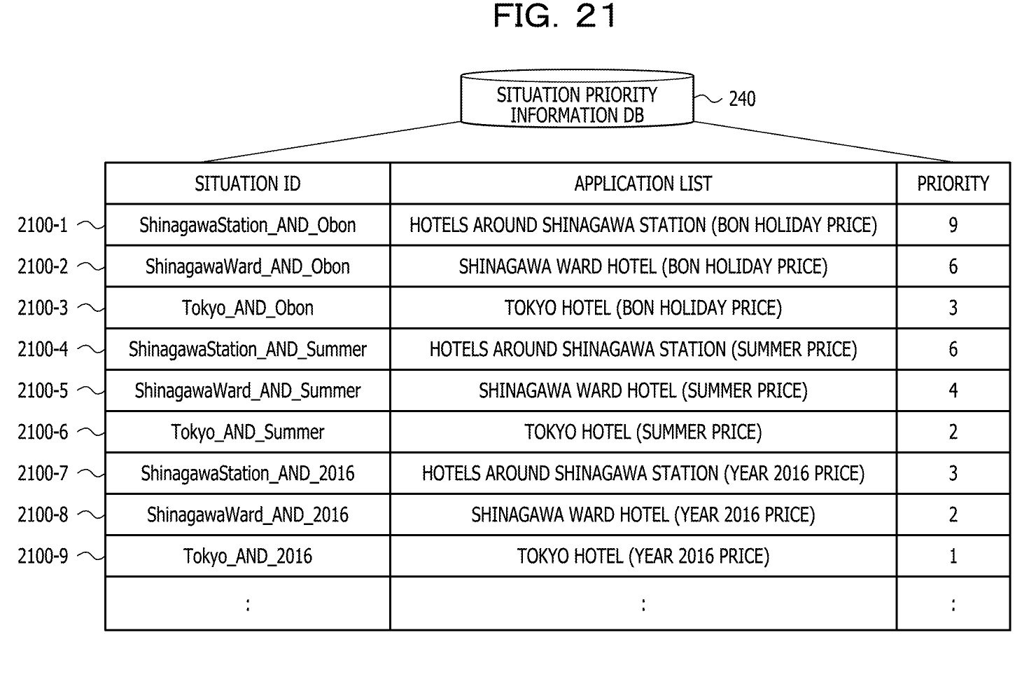

In this manner, the situation of the information processing device 101 may be judged with both of a place and a time taken into account. The application store 230 and the situation priority information DB 240 store, for example, contents as illustrated in FIGS. 20 and 21 when a situation indicates “a place and a time”.

FIG. 20 is a diagram (2) illustrating an exemplary stored content of the application store 230. In FIG. 20, the application store 230 includes fields of an application name, an application body, and a tag, and stores application information (for example, application information 2000-1 to 2000-9) as a record by setting information to each field.

FIG. 21 is a diagram (2) illustrating an exemplary stored content of the situation priority information DB 240. In FIG. 21, the situation priority information DB 240 includes fields of a situation ID, an application list, and a priority. The situation priority information DB 240 stores situation priority information (for example, situation priority information 2100-1 to 2100-9) as a record by setting information to each field.

In this manner, when a situation indicates “a place and a time”, an application with both of the place and the time taken into account may be registered. For example, an application having an application name of “Hotels around Shinagawa Station (Bon holiday price)” is only distributed at Shinagawa Station during Bon holiday.

When a situation indicates “a place and a time”, a priority may be calculated based on, for example, the priority of a situation indicating the place and the priority of the situation indicating the time. The following describes the priority of the situation identified by situation ID “ShinagawaStation_AND_Obon” as an example.

This situation indicates combination of the situation identified by situation ID “ShinagawaStation” and a situation identified by situation ID “Obon”, in other words, a situation with a place of “Shinagawa Station” and a time of “Bon holiday duration”. The Bon holiday duration is a duration between 00:00:00 on Aug. 14, 2016 and 23:59:59 on Aug. 20, 2016.

In this case, the server 201 calculates the priority of the situation identified by situation ID “ShinagawaStation_AND_Obon” based on the priority of the situation identified by situation ID “ShinagawaStation” and the priority of the situation identified by situation ID “Obon”.

The situation identified by situation ID “ShinagawaStation” has a priority of “3” (refer to FIG. 7, for example). The situation identified by situation ID “Obon” has a priority of “3” (refer to FIG. 7, for example). For example, the server 201 calculates the priority “9” of the situation identified by situation ID “ShinagawaStation_AND_Obon” as the product the priority “3” of the situation identified by situation ID “ShinagawaStation” and the priority “3” of the situation identified by situation ID “Obon”.

A situation represents sensing information (such as an angle (direction) and a speed) and system information (such as a battery remaining amount and a disk remaining amount) other than a time and a place. For example, when a terminal is directed to a notice board, a list of notices on the notice board is displayed on the terminal. Then, when the terminal is directed to a particular notice, detail information related to the notice is displayed. For example, when a terminal is in a car traveling at a speed in a certain range, it is determined that the car is driven safely and a coupon is downloaded to the terminal. For example, at a smaller battery remaining amount, the current application is updated to an application having a higher energy saving effect than that of the current application. For example, at a smaller disk remaining amount, the current application is updated to an application with a higher ratio of compression of data such as a picture.

As described above, the information processing device 101 according to the embodiment may acquire, from the server 201, an application that corresponds to a condition (situation start condition) satisfied by acquired observation information and to which a priority is applied based on an inclusive relation with any other condition satisfied simultaneously with the above condition in some cases, and may register the application to the display candidate application list 900. Then, the information processing device 101 may determine one or a plurality of applications based on the priorities of one or a plurality of applications registered in the display candidate application list 900.

Accordingly, applications displayed on the display 305 may be narrowed down and a display order of the applications may be determined according to the priorities applied to applications based an inclusive relation between a plurality of conditions that are simultaneously satisfied in some cases.

The information processing device 101 may determine, based on acquired observation information, whether a condition corresponding to any of the applications registered in the display candidate application list 900 has become unsatisfied, in other words, the situation end condition of a situation corresponding to the application has become satisfied. Then, when it is determined that the condition has become unsatisfied, the information processing device 101 may delete the application from the display candidate application list 900.

Accordingly, when the information processing device 101 has left the situation, any application corresponding to the situation may be deleted. As a result, any application not suitable for the situation of the information processing device 101 is not displayed on the display 305, and a memory use amount may be reduced.

The information processing device 101 may compare the priorities of applications for an identical usage based on tags of one or a plurality of acquired applications, and may determine applications for each usage based on a result of the comparison. Then, the information processing device 101 may display applications for each usage in a determined display manner.

Accordingly, for example, an application having the highest priority for each usage may be displayed, which allows the user to easily specify an application useful in the current situation. When a plurality of applications for a certain usage has been acquired and the applications have priorities higher than those of applications for any other usage, display of applications for an identical usage, in other words, for similar usages, is not prioritized.

The server 201 according to the embodiment may set a priority corresponding to a condition based on an inclusive relation of a condition related to a situation with another condition that is simultaneously satisfied in some cases. Specifically, for example, when a condition is included in another condition, the server 201 may set a higher priority to this condition than to the other condition. When a condition includes another condition, the server 201 may set a lower priority to this condition than the other condition.

Accordingly, for example, when a condition (situation) indicates a place, the server 201 may apply a higher priority to an application corresponding to this condition with a smaller area. For example, when a condition (situation) indicates a time, the server 201 may apply a higher priority to an application corresponding to this condition with a shorter time length.

Accordingly, the information processing system 200 according to the embodiment may narrow down applications useful to the user in the situation of the information processing device 101 without using a use history or the like of the user, thereby easily reducing display complication at the information processing device 101.

The information processing method described in the present embodiment may be achieved through execution of a computer program prepared in advance by computers such as a personal computer and a work station. This information processing program is recorded in computer-readable recording media such as a hard disk, a flexible disk, a CD-ROM, a magneto-optical disk (MO), a digital versatile disk (DVD), and a Universal Serial Bus (USB) memory, and is executed by a computer through reading from the recording medium. The information processing program may be distributed through a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing method executed by an information processing device including a sensor and a processor, the information processing method comprising:
acquiring, by the sensor, observation information indicating a situation;
extracting, by the processor, one or more contents corresponding to the observation information from among a plurality of contents by referring to information in which an identifier identifying a situation and a content are associated with each other for each of the plurality of contents;
determining one or more target contents from among the one or more contents based on priorities associated with the one or more contents; and
executing a program of one of the determined one or more target contents.

2. The information processing method according to claim 1, further comprising:
newly acquiring the observation information after having determined the one or more target contents; and
deleting the specified content from among the one or more contents when it is determined, based on the newly acquired observation information by referring to situation definition information associating each of a plurality of identifiers for identifying the situation with a condition on which a situation indicated by the identifier starts, that a content the condition of which is unsatisfied is specified from among the one or more contents.

3. The information processing method according to claim 1,
wherein the situation priority information additionally associates each of a plurality of contents with a tag indicating usage of the content, and
wherein the determining includes:
comparing the priorities of contents having identical usage based on the tags of the one or more contents, and
determining the one or more target contents for each usage based on a result of the comparison.

4. The information processing method according to claim 3, further comprising
displaying, for each usage, the one or more target contents determined for each usage.

5. The information processing method according to claim 1, wherein, in the situation priority information,
when a first identifier is included in a second identifier among the plurality of identifiers, a higher priority is applied to a content corresponding to the first identifier than to a content corresponding to the second identifier, and
when the first identifier includes the second identifier, a lower priority is applied to the content corresponding to the first identifier than to the content corresponding to the second identifier.

6. The information processing method according to claim 1,
wherein, in the situation priority information, when the identifier indicates a place, a higher priority is applied to a content corresponding to the identifier for a smaller area.

7. The information processing method according to claim 1,
wherein, in the situation priority information, when the identifier indicates a time, a higher priority is applied to a content corresponding to the identifier for a shorter time length.

8. An information processing device comprising:
a sensor configured to acquire observation information indicating a situation; and
a processor coupled to the sensor and configured to:
extract one or more contents corresponding to the observation information from among a plurality of contents by referring to information in which an identifier identifying a situation and a content are associated with each other for each of the plurality of contents,
determine one or more target contents from among the one or more contents based on priorities associated with the one or more contents, and
execute a program of one of the determined one or more target contents.

9. The information processing device according to claim 8, wherein the processor is configured to:
newly acquire the observation information after having determined the one or more target contents; and
delete the specified content from among the one or more contents when it is determined, based on the newly acquired observation information by referring to situation definition information associating each of a plurality of identifiers for identifying the situation with a condition on which a situation indicated by the identifier starts, that a content the condition of which is unsatisfied is specified from among the one or more contents.

10. The information processing device according to claim 8,
wherein the situation priority information additionally associates each of a plurality of contents with a tag indicating usage of the content, and
wherein the determining includes:
comparing the priorities of contents having identical usage based on the tags of the one or more contents, and
determining the one or more target contents for each usage based on a result of the comparison.

11. The information processing device according to claim 10, wherein the processor is configured to
display, for each usage, the one or more target contents determined for each usage.

12. The information processing device according to claim 8, wherein, in the situation priority information,
when a first identifier is included in a second identifier among the plurality of identifiers, a higher priority is applied to a content corresponding to the first identifier than to a content corresponding to the second identifier, and
when the first identifier includes the second identifier, a lower priority is applied to the content corresponding to the first identifier than to the content corresponding to the second identifier.

13. The information processing device according to claim 8,
wherein, in the situation priority information, when the identifier indicates a place, a higher priority is applied to a content corresponding to the identifier for a smaller area.

14. A non-transitory computer-readable storage medium storing a program that causes a processor included in an information processing device including a sensor to execute a process, the process comprising:
acquiring, by the sensor, observation information indicating a situation;
extracting, by the processor, one or more contents corresponding to the observation information from among a plurality of contents by referring to information in which an identifier identifying a situation and a content are associated with each other for each of the plurality of contents;
determining one or more target contents from among the one or more contents based on priorities associated with the one or more contents; and
executing a program of one of the determined one or more target contents.
